(19) United States
(12) Patent Application Publication
(10) Pub. No.: US 2004/0225532 A1
(43) Pub. Date: Nov. 11, 2004

(54) System, method, and article of manufacture for providing automated podiatry-related consultation

(76) Inventors: Grigorii Gadiyak, Woodstock, MD (US); Shari M. Tomasetti, Brighton, MA (US); Mark Jacobs, Arlington, VA (US); Daisy Dewitt, Silver Spring, MD (US)

Correspondence Address: OFFICE OF THE STAFF JUDGE ADVOCATE, U.S. ARMY MEDICAL RESEARCH AND MATERIEL COMMAND, ATTN: MCMR-JA (MS. ELIZABETH ARWINE), 504 SCOTT STREET, FORT DETRICK, MD, 21702-5012, US

(21) Appl. No.: 10/721,776

(22) Filed: Nov. 26, 2003

Related U.S. Application Data
(60) Provisional application No. 60/429,336, filed on Nov. 27, 2002.

(51) Int. Cl. G06F 17/60

(52) U.S. Cl. 705/2

(57) ABSTRACT

The present invention is directed to a consultation management telecommunication system for providing podiatry-related consultation to a patient. A shoe report including information informing the patient of a list of recommended shoes to be worn by the patient to minimize or prevent podiatry-related injuries is provided based on the consultation. The system preferably comprises a computer program registration module, a computer program consultation creation module, a computer program consultation interview module, a computer program shoe recommendation module, and at least one workstation including a microprocessor for executing the computer program modules.

### I. FIELD OF THE INVENTION

The present invention generally relates to podiatry-related consultation and consultation management and more particularly, to the same via telecommunications technology.

### II. BACKGROUND OF THE INVENTION

Studies have shown that people tend to suffer a significant number of foot-related injuries while engaging in running and jogging. For example, heel spurs, stress fractures, and ankle sprains are among the injuries often suffered by runners and joggers. Although some of these injuries are believed to be related to poor habits of the runner or jogger (for example, overtraining muscles and failure to stretch muscles), others are believed to be related to the use of inappropriate shoes. For example, studies have shown that hundreds of thousands of soldiers who run as part of their unit or individual physical training regimen incur injuries, often due to wearing a shoe that does not accommodate their individual running gait. In addition, it is believed that many injuries suffered by athletes occur due to wearing inappropriate shoes.

Foot analysis may be conducted to study an individual's pronation and gait (for example), a unique set of actions and reactions that an individual's feet perform while in motion to support, cushion, and balance the individual's body. Studies have shown that certain types of shoes are best suited for certain types of gaits and pronation patterns. Although gait and pronation analysis requires expert medical knowledge, patients requiring such analysis often do not have access to appropriately trained medical professionals. Thus, gait and pronation analysis is an ideal candidate for telemedicine.

Telemedicine, the use of information and telecommunications technology to provide and support health care when distance separates the participants, is receiving increasing attention not only in remote areas where health care access is troublesome but also in urban and suburban locations. Although a variety of medical specialties have been offered in the telemedicine field including radiology, pathology, and psychiatry, there still exists a need for providing podiatry-related consultation to a patient via a consultation management telecommunications system.

Such a system should allow remotely located health providers to communicate with consulting health care providers who can perform expert podiatry-related diagnosis in near real time. Such a system should also provide in-depth podiatry-related patient consultations and also allow system management of podiatry-related patient consultations.

### III. SUMMARY OF THE INVENTION

The present invention is directed to a consultation management telecommunication system for providing podiatry-related consultation to a patient. The system preferably comprises a computer program registration module including computer readable instructions for allowing user registration with the system, a computer program consultation creation module including computer readable instructions for accepting patient activity information for assisting in the consultation of a patient, a computer program consultation interview module including computer readable instructions for accepting technical podiatry-related information for assisting in the consultation of the patient, a computer program shoe recommendation module including computer readable instructions for generating a technical shoe recommendation based on the consultation of the patient, and at least one workstation including a microprocessor for executing the computer program modules.

In at least one embodiment of the present invention, the consultation management telecommunication system further comprises a computer program authorization module including computer readable instructions for allowing the user to authorize the registration.

In at least one embodiment of the present invention, the consultation management telecommunication system of the invention further comprises a computer program technical report module including computer readable instructions for allowing the user to generate a technical report based on the technical shoe recommendation.

A computer program editor module including computer readable instructions for allowing the user to update, alter, add, and delete information pertaining to the system is also included in the system in at least one embodiment of the invention.

### IV. BRIEF DESCRIPTION OF THE DRAWINGS

Like reference numerals in the figures represent and refer to the same element or function.

FIG. 1 is a diagram depicting an exemplary consultation management telecommunication system according to an embodiment of the present invention.

FIG. 2 is a block diagram depicting an exemplary computer system capable of executing the computer program modules of the consultation management telecommunication system according to an embodiment of the present invention.

FIG. 3 is a flow diagram depicting the steps involved at a referral site of a consultation management telecommunication system according to an embodiment of the present invention.

FIG. 4 is a flow diagram depicting the steps involved at a consultant site of a consultation management telecommunication system according to an embodiment of the present invention.

FIG. 5 is a snapshot of an exemplary entry screen depicting a group of initial options viewed by a user of the system according to the embodiment of the present invention.

FIG. 6 is a snapshot of an exemplary on-line patient registration form according to an embodiment of the present invention.

FIG. 7 is a snapshot of an exemplary on-line patient registration update form according to an embodiment of the present invention.

FIG. 8 is a snapshot of an exemplary screen after a patient has been registered according to an embodiment of the present invention.

FIG. 9 is a snapshot of an exemplary screen depicting a plurality of primary and secondary options offered to a user of the consultation management telecommunication system according to an embodiment of the present invention.

FIG. 10 is a snapshot of an exemplary user registration approval screen according to an embodiment of the present invention.

FIG. 11 is a flow diagram illustrating the steps involved in obtaining information for the on-line interview data sheet according to an embodiment of the present invention.

FIG. 12 is a snapshot of an exemplary initial form for the on-line interview data sheet according to an embodiment of the present invention.

FIG. 13 is a snapshot of an exemplary form for entering training data into the on-line interview data sheet according to an embodiment of the present invention.

FIG. 14 is a snapshot of an exemplary form for entering shoe characteristics into the on-line interview data sheet according to an embodiment of the present invention.

FIG. 15 is a snapshot of an exemplary form for entering feet characteristics into the on-line interview data sheet according to an embodiment of the present invention.

FIG. 16 is a snapshot of an exemplary form presenting a graphical display with associated selection components for allowing data to be entered into the on-line interview data sheet according to an embodiment of the present invention.

FIG. 17 is a snapshot of an exemplary form for allowing foot analysis data to be entered into the on-line interview data sheet according to an embodiment of the present invention.

FIG. 18 is a snapshot of an exemplary form for allowing foot characteristic data to be entered into the on-line interview data sheet according to an embodiment of the present invention.

FIG. 19 is a snapshot of an exemplary form for allowing a user to upload graphical images to the system according to an embodiment of the present invention.

FIG. 20 is a snapshot of an exemplary screen for allowing a user to select an editor option from a group of editor options according to an embodiment of the present invention.

FIG. 21 is a snapshot of an exemplary editor screen for presenting a list of shoes to a user according to an embodiment of the present invention.

FIG. 22 is a snapshot of an exemplary editor form for adding a new shoe name along with its associated information into the on-line interview data sheet according to an embodiment of the present invention.

FIG. 23 is a snapshot of an exemplary form for allowing a user to update an existing shoe recommendation in the system according to an embodiment of the present invention.

### V. DETAILED DESCRIPTION OF THE INVENTION

### Table of Contents

A. Overview

B. System

C. General Operational Flow of Consultation Process

D. Menu Program Module

E. Registration with the System

F. Primary Menu Options

G. On-line Patient Activity Data Sheet

H. Create On-line interview data sheet

I. Create Shoe Recommendations

J. Create New Shoe Clinic Report

K. Editor

A. Overview

The present invention allows one to minimize or prevent podiatry-related injuries resulting from wearing inappropriate shoes (for example, improperly sized shoes). The invention provides podiatry-related patient consultation including gait and pronation analysis and allows a medical professional to recommend a particular shoe for a patient based on the consultation. Consultation preferably occurs at a referral site where the patient is initially asked a set of questions relating to exercise activity (for example, jogging habits). A medical professional then preferably interviews the patient to obtain technical information regarding the characteristics of the patient's feet, for example. In addition, the medical professional takes video images of the patient while the patient is in the process of exercising (for example, while running on a treadmill). After the interview, the technical information and the images are preferably transmitted to a consulting site. A medical professional at the consulting site preferably reviews and analyzes the technical information and views the video images. Finally, the medical professional at the consulting site creates a shoe report including information informing the patient of a list of recommended shoes to be worn by the patient to minimize or prevent podiatry-related injuries.

B. System

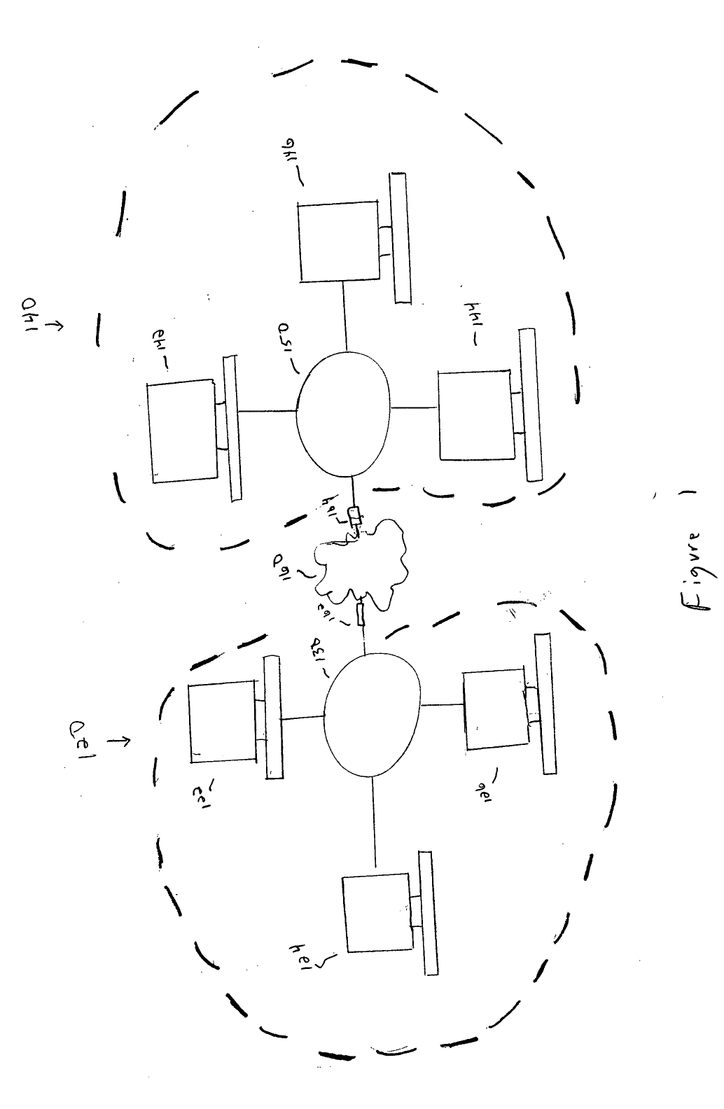

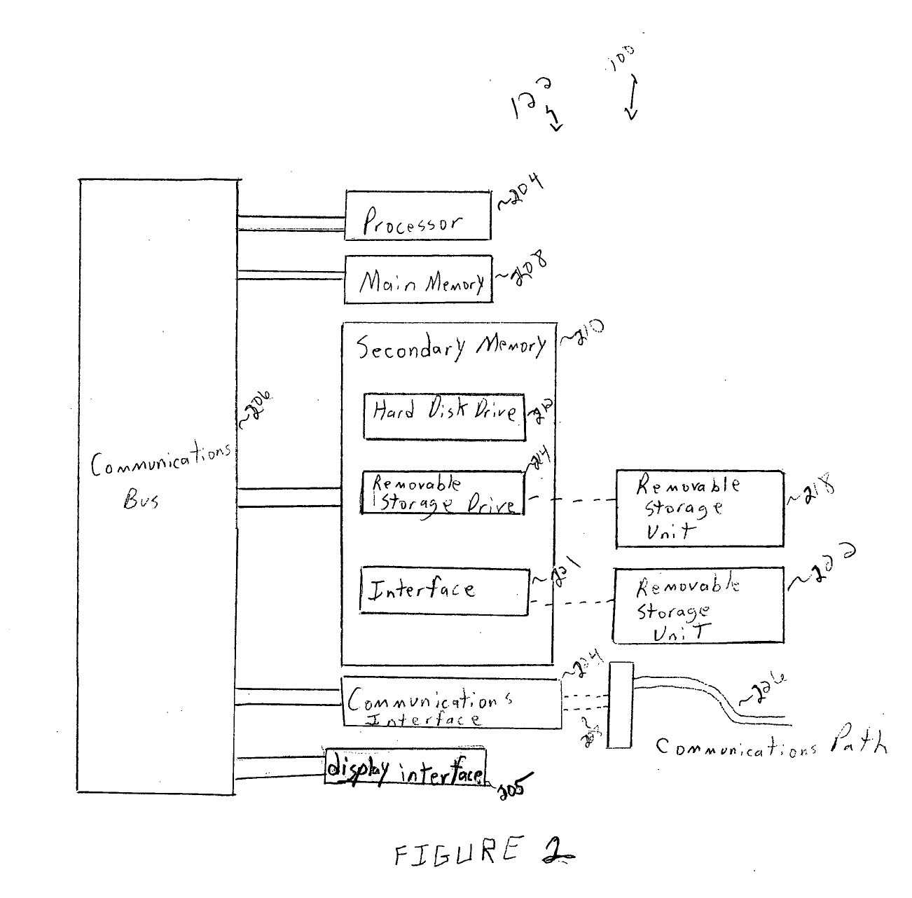

The exemplary consultation management telecommunication system 100 of FIG. 1 preferably includes referral site 120 and consulting site 140. As depicted in FIG. 1, the referral site 120 is preferably electronically coupled to the consultant site 140 through the Internet 160 via the bridges or routers 162 and 164. In some embodiments of the invention, however, the bridges or routers 162 and 164 are not present. In such embodiments, the hubs 130 and 150 are preferably directly electronically coupled to the Internet. In such a situation, the hubs 130 and 150 are preferably replaced by bridges or any other routing mechanism, as would be known to one skilled in the relevant art(s). Further, it should be noted, however, that in some embodiments of the present invention, the referral site 120 is preferably electronically coupled to the consultant site 140 directly via a main bridge (not shown). In such a configuration, the Internet 160 is replaced by the main bridge, and the system preferably operates on a private network (for example, an intranet), as opposed to the Internet.

The referral site 120 preferably includes workstations 122, 124, and 126. The workstations 122, 124, and 126 preferably communicate electronically with each other through the hub 130 according to a telecommunications method well known to those of ordinary skill in the art. For example, a user using workstation 122 on the referral site 120 may email a system administrator or a site administrator using workstation 126 to notify the administrator with a question regarding the system. The referral site 120 is preferably the site where a requesting health care provider resides. The requesting health care provider is responsible for interviewing the patient to obtain technical podiatry-related information (for example, obtaining information from the patient relating to effects of previous injuries and performing imaging of the patient's gait). The referral site 120 is also preferably the location at which the patient registers with the system, as will be described further below.

The consultant site 140 preferably includes workstations 142, 144, and 146. The workstations 142, 144, and 146 preferably communicate through the hub 150. The consultant site 140 is preferably the site where the consulting health care provider resides. The consulting health care provider is responsible for analyzing and diagnosing the results submitted by the referral site 120 (for example, creating a report which includes recommendations and solutions for the problems of the patient).

Referring to FIG. 2, an exemplary workstation 122 for implementing the computer program modules of the present invention is shown. It should be noted that the term workstation is used herein to refer to any computer system with or without associated input and output devices. For example, a workstation of the present invention may be a desktop computer, a laptop computer, palmtop computer, or personal digital assistant (PDA) or the like, with their associated input (for example, a keyboard) and output (for example, a computer display) devices. Exemplary workstations used to implement the invention include, but are not limited to, Apple®, Sun Microsystems®, IBM®, or IBM®-compatible personal computers, and Dell® Computers. Exemplary hardware for implementing the present invention includes an IBM®-compatible computer system having recommended specifications of a Pentium® 90 MHz microprocessor, at least 64 MB RAM, a PCMCIA Card Reader, and a computer display monitor.

Recommended operating systems include Microsoft® Windows® 95, 97, 98, 2000, NT, and the Macintosh operating system. Recommended Internet browsers include Netscape® and Internet Explorer.®

The workstation 122 includes one or more processors, such as processor 204 (for example, a microprocessor). The processor 204 is connected to a communications bus 206. It should be noted, however, that the processor 204 can also be a cross-over bar or another network.

The processor 204 of the workstation 122 preferably executes the computer program modules of the present invention. The processor may be housed in one of the computer systems described above. It should also be noted that various software embodiments are described in terms of the exemplary workstation 122 depicted in FIG. 2. After reading the description herein, it will become apparent to a person skilled in the relevant art how to implement the invention using other computer systems and/or computer architectures.

Workstation 122 may include a communications interface 224 that forwards graphics, text, and other data from the communications bus 206 for display on a display device (not shown) coupled to the system. Workstation 122 also includes a main memory 208, preferably random access memory (RAM), and may also include a secondary memory 210. The secondary memory 210 may include, for example, a hard disk drive 212 and/or a removable storage drive 214, representing a floppy disk drive, a magnetic tape drive, or an optical disk drive, etcetera. The removable storage drive 214 reads from and/or writes to a removable storage unit 218 in a manner well known to those skilled in the relevant art. Removable storage unit 218 represents a floppy drive, magnetic tape, memory stick, or optical disk. As will be appreciated by those skilled in the art, the removable storage unit 218 includes a computer usable storage medium having stored therein computer software and/or data.

In alternative embodiments, secondary memory 210 may include other similar means for allowing the computer program modules of the present invention to be loaded into the components of the workstation 122. Such means may include, for example, the removable storage unit 218 and an interface 221. Examples of such may include a program cartridge and cartridge interface (such as that found in video game devices), a removable memory chip (such as an EPROM or PROM) and associated socket, and other removable storage units 222 which allow software and data to be transferred from the removable storage unit 222 to the workstation 122.

Workstation 122 may also include a communications interface 224. The communications interface 224 allows software and data to be transferred between the workstation 122 and external devices. Examples of the communications interface 224 include but are not limited to, a modem, a network interface, an Ethernet card, a communications port, and a PCMCIA slot and card. Software and data transferred via the communications interface 224 are preferably in the form of signals 228, which may be electronic, electromagnetic, optical, or other signals capable of being received by the communications interface 224. The signals 228 are preferably provided to the communications interface 224 via a communications path (for example, a channel) 226. The path 226 carries signals 228 and may be implemented using wire, cable, fiber optics, a phone line, a cellular phone link, an RF link and other communications channels.

The term computer program product as used herein generally refers to media such as a computer program medium or a computer usable medium. Removable storage drive 214, a hard disk installed in hard disk drive 212, and signals 228 are examples of computer program media and serve as means for providing software to the workstation 122.

In accordance with an embodiment of the invention, the computer program modules of the present invention may be stored in main memory 208 and/or secondary memory 210. The computer program modules may also be received via communications interface 224. Such computer program modules, when executed, enable the workstation 122 to perform the features of the present invention as discussed herein. More specifically, the program modules of the present invention, when executed, enable the processor 204 to perform the features of the present invention. Accordingly, such computer program modules represent controllers of the workstation 122.

One skilled in the art will recognize that the computer readable instructions included in the computer program modules of the present invention can be in the form of any viable computer programming language. For example, a high-level programming language such as C, C++, Ada, LISP, Cobol, Fortran, or Beginners All-Purpose Symbolic Instruction Code (BASIC) can be utilized to program the program modules of the present invention. It should be noted that the term “program module” is used herein to refer to a set of computer instructions for accomplishing a task. Thus, as used herein, a program module may or may not be embodied in the same electronic file or medium.

In an embodiment where the invention is implemented using software, the software may be stored in a computer program product or an article of manufacture and loaded into the workstation 122 using removable storage drive 214, hard drive 212, or communications interface 224. The control logic (for example, software) of the present invention, when executed by the processor 204, causes the processor 204 to perform the functions of the invention as described herein.

In other embodiments, the present invention is implemented primarily in hardware using, for example, hardware components such as application specific integrated circuits (ASICs). Implementation of a hardware state machine so as to perform the functions described herein will be apparent to persons skilled in the art after being provided with the description herein.

In addition to the processor described above, the workstation 122 preferably includes an input device (not shown) in communication with the processor to allow a user to interact with the computer program modules. For example, in at least one embodiment, the present invention employs a keyboard as an input device. A computer mouse, lightpen, or touchscreen, for example, may also be employed with the present invention. An output device in communication with the processor may also be utilized to provide information relating to the consultation management telecommunication system of the invention. Such output devices may include, for example, a computer display monitor and/or a computer speaker. A touch screen may also be utilized as an input/output device. In such a configuration, input/output functionality is provided by the same physical structure.

C. General Operational Flow of Consultation Process

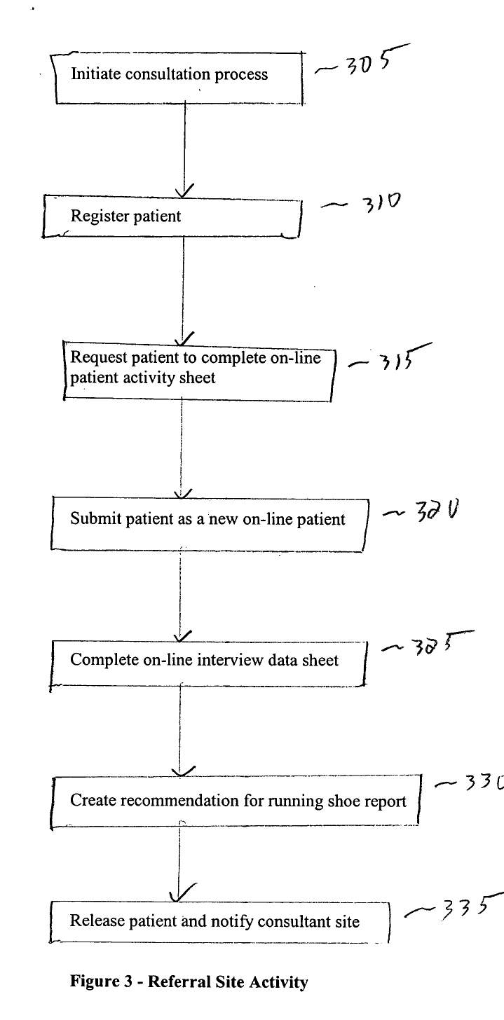

FIG. 3 illustrates the steps preferably involved in the consultation management process at the referral site of the consultation management telecommunication system 100. Control begins with step 305. In step 305, the consultation management process of the present invention is preferably initiated. For example, a referring health care provider may explain the process of the consultation management telecommunication system of the present invention to a patient during an appointment with the patient at the referral site. After the explanation, the health care provider preferably asks the patient whether she or he wishes to employ the services of the system of the invention. Providing that the patient desires to do so, control proceeds to step 310.

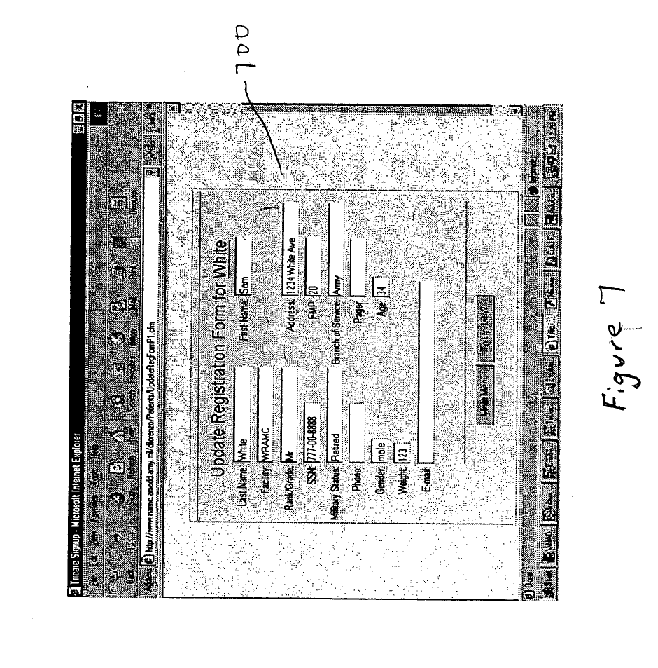

In step 310, the referring health care provider preferably registers the patient with the system. As will be described in further detail below, there are two methods by which a patient can be registered with the system. In the first method of the present invention, a patient selects an option at his workstation that allows him to register for the system (the patient will then have to be authorized to use the system), as will be later described in detail. In the second method, described in FIG. 3, the referring health care provider preferably registers the patient as part of initiating a new consultation. In particular, in step 310, patient registration is preferably accomplished by allowing the referring health care provider to enter demographic information of a patient, for example, a name, other identification information, and an address, in an on-line electronic form. Patient registration will be described in further detail in the text accompanying FIG. 6. After patient registration is completed in step 310, control resumes with step 315.

In step 315, the referring health care provider preferably completes an on-line patient activity sheet for the patient (alternatively, the patient may complete the sheet), as will be described in further detail below. The on-line patient activity sheet is an on-line sheet that includes a series of questions to be answered on-line by the patient. The questions are podiatry-related and preferably include, but are not limited to, questions such as the name and style of the patient's current shoes and the length of time the patient has worn the shoes, for example. After the referring health care provider completes the on-line patient activity sheet for the patient, control resumes with step 320.

In step 320, the referring health care provider preferably submits the patient as a new on-line patient. In this step, an administrator or the referring health care provider also preferably authorizes the new patient to be a part of the system of the invention. In particular, the referring health care provider or the administrator may approve the patient by selecting an approval button, for example.

In step 325, the referring health care provider preferably completes the on-line interview data sheet which serves as a consultation request to the consulting site upon its receipt. The on-line interview data sheet preferably includes answers to questions relating to technical podiatry-related information such as training injuries, exercise schedules, exercise distance (for example, running distance), and flexibility and strength training, for example. The technical podiatry-related information also preferably includes but is not limited to, shoe tread wear patterns, height of foot arch, foot shape determination and other shoe and feet characteristics.

In addition to the above technical podiatry-related information, the interview data sheet preferably includes images of the patient's gait, for example. These images are preferably taken by a specialist at the referring site and attached to the interview data form. For example, the specialist may use a video camera to obtain images of a patient while running. The images are preferably converted to an electronic digital format, for example, and attached to the interview data form to be stored with the other technical podiatry-related information described above.

In step 330, the referring health care provider preferably creates a recommendation for a shoe report (for example, a running shoe report) to be generated by a consulting health care provider at the consultant site.

In step 335, the patient is preferably released from the referral site, and the referral site preferably notifies the consultant site that it has submitted a recommendation for a shoe report.

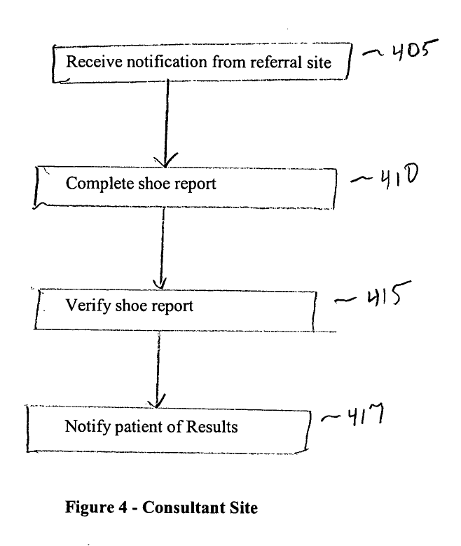

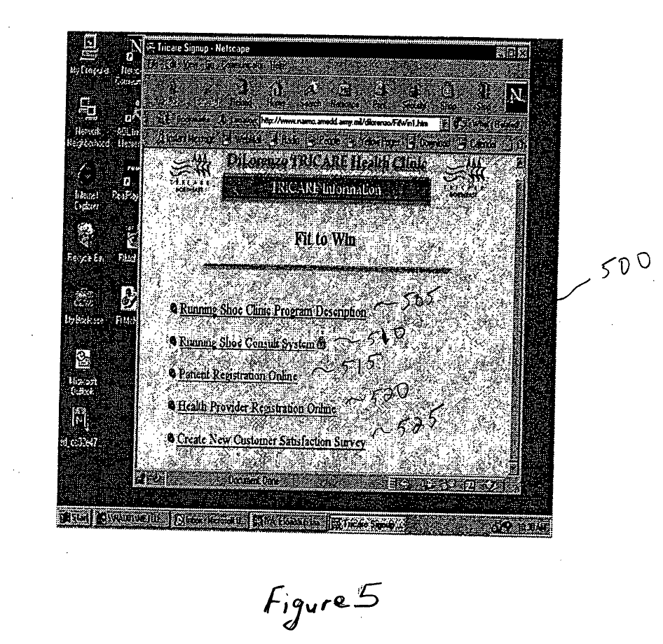

In FIG. 4, a flow diagram of the steps involved at the consultant site, control begins with step 405. In step 405, the consultant site receives notification from the referral site that the referral site has completed its role in the consultation management process. For example, the consultant site may receive an automatic notification after the referral site completes the steps in FIG. 3. Alternatively, the referring health care provider may send an email to the consultant site to indicate that the referral site has completed its task.

In step 410, the consulting health care provider reviews and analyzes the on-line patient activity sheet and the interview data sheet submitted by the referral site. After the review and analyzation process, the consulting health care provider completes a shoe report which includes solutions and correction remedies for the patient based on the information submitted by the referral site. In step 415, the shoe report is verified. Finally, in step 417, the patient is notified of the results in the report. For example, an email may be submitted to the patient with an attached copy of the report.

D. Menu Program Module

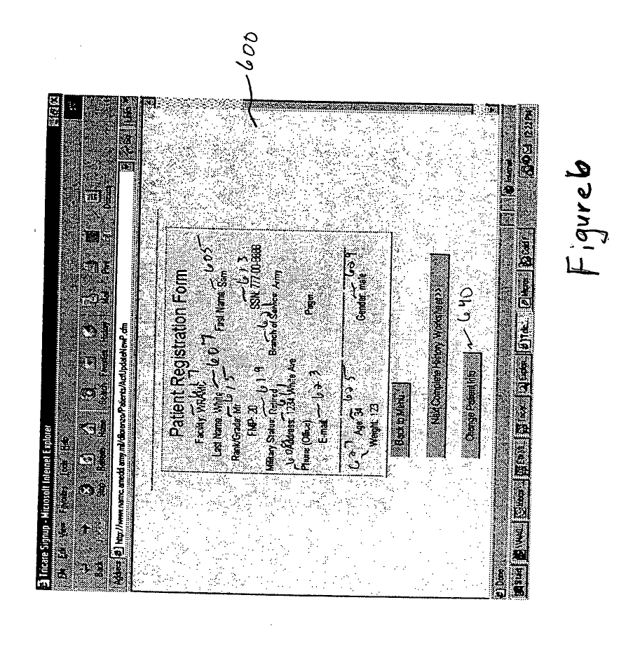

In at least one embodiment of the present invention, a menu program module is provided for allowing a user of the system to select an option in menu-based format. As shown in FIG. 5, the menu program module preferably presents the user with an entry display screen 500 including the following options: running shoe clinic program description option 505 (provides a description of the consultation management telecommunication system of the present invention and a tutorial in some embodiments); running shoe consult system option 510 (provides access to the actual consultation management telecommunication system); patient registration online option 515 (an option for allowing a patient to be registered to use the system of the invention); health provider registration online option 520 (an option for allowing a health care provider to register to use the system); and create new customer satisfaction survey option 525 (an option for allowing a patient to complete an on-line survey regarding satisfaction of the use of the system).

E. Registration with the System

It should be noted that all individuals (for example, patients and health care providers at the referring and consulting sites) must register with the system. As previously noted, the present invention presents two methods by which a patient may register to use the consultation management telecommunication system of the present invention. One of the methods is by selecting “patient registration on-line” option 515 in FIG. 5. The other method of registration is accomplished during the creation of a new consultation by the referring health care provider at the referral site, as described in FIG. 1 and will be described in greater detail below.

Upon selecting “patient registration on-line” option 515, the system of the present invention displays an on-line patient registration form 600, as shown in FIG. 6, for example. The on-line patient registration form preferably includes the following fields: First Name field 605; Last Name field 607; Telephone Number field 609; Address field 611; Patient Identification Number field 613; Rank or Title field 615; Medical Facility field 617; Status field 619; Department or Branch of Service field 621; Email address field 623; Age field 625; Weight field 627; and Gender field 629. It should be noted that the forgoing fields are exemplary and not exhaustive. Various combinations and subcombinations of the forgoing fields may be employed to suit the environment in which the invention is used. Other exemplary fields include a username and password field. As these fields are self-explanatory, they will not be described further herein. After being presented with the on-line form, the patient preferably enters the required information by typing text into the various fields. In some fields, the patient is preferably presented with a radio button to indicate a particular selection. For example, the patient may be provided with a choice in the rank or title field 615 such as “Mr.,” “Ms.,” or “Col.” Alternatively, the patient may be allowed to select one of the choices by highlighting the choice. After being presented with the description herein, one skilled in the art will recognize that other alternatives for choice selection in the various fields are possible. After the patient has completed data entry for the on-line form, the patient preferably selects an option (for example, a “next” button) to indicate that he or she desires to have his on-line form approved, as patient registration must preferably be approved by an individual having requisite authority (for example, a site administrator) after completion.

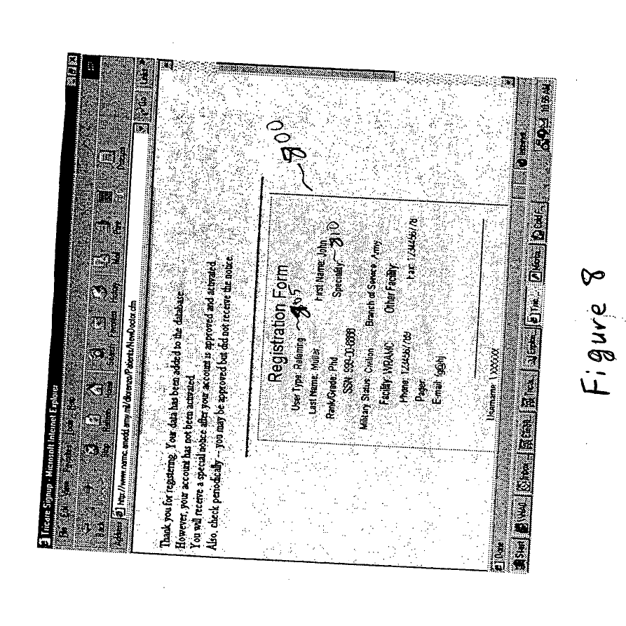

The user (for example, the patient) may update or change the recorded information in the on-line registration form if he or she so desires. For example, in FIG. 6, the patient may “click” the “change patient info” button 640 to obtain an on-line form 700 such as that described in the text accompanying FIG. 7. The patient then preferably enters new information in the on-line form 700 to update its information.

After the registration is approved, the patient is presented with a patient on-line activity data sheet. It should be noted, however, in at least one embodiment, the patient is presented with an on-line activity data sheet before the registration is approved. In another embodiment, the on-line activity data sheet is not accessible through patient registration. The on-line activity data sheet may also be accessed via a primary option for creating a patient consult and will be further described in the text below describing that particular option.

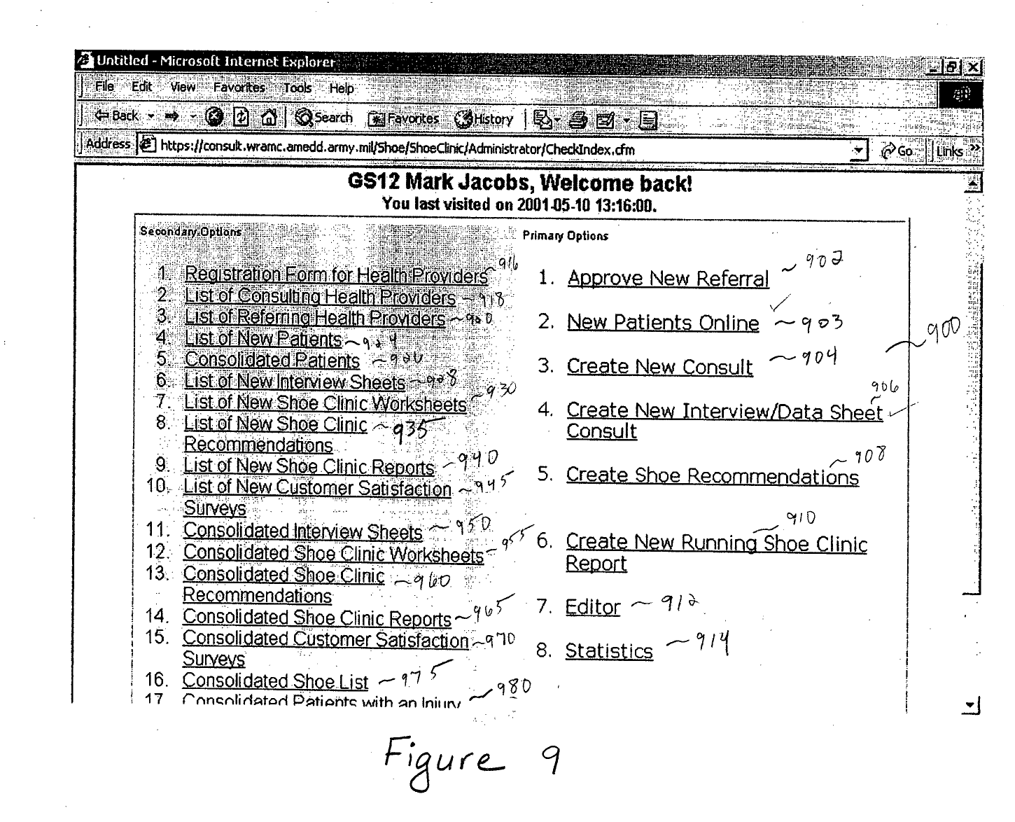

Upon selection of the “health provider registration on-line” option in FIG. 5, a health care provider registration form is presented. For example, exemplary on-line health care provider registration form 800 is shown in FIG. 8. The on-line health care provider registration form 800 preferably includes fields such as those mentioned in FIG. 5. In addition, however, the on-line health care provider registration form also includes a username field and a password field. It should be noted that in at least one embodiment of the present invention, a “user type” field 805 is preferably included in the on-line form to indicate whether the health care provider is a referring physician or a consulting physician. In addition, “specialty” field 810 is preferably included in the form 800 to indicate the medical specialty of the health care provider. After the health care provider has completed data entry for the on-line form, he or she preferably selects a “registration submit” option (not shown in FIG. 8) to indicate that he or she desires to have the on-line form approved, as provider registration must preferably be approved by an individual having requisite authority (for example, a site administrator or manager) after completed. After submitting the on-line form, the user preferably receives registration confirmation from the site administrator (for example, the referring site administrator), for example, indicating that the health care provider's registration was confirmed.

F. Primary Menu Options

Upon selection of the “running shoe consult system” option from the entry screen (shown in FIG. 5) and entering the requisite username and password, the user is presented with a menu including a plurality of primary options and secondary options. Such options are preferably presented by the computer program menu module responsible for providing the user with the entry display screen 500 (in FIG. 5). It should be noted, however, that another computer program menu module may be responsible for providing the user with the primary menu options.

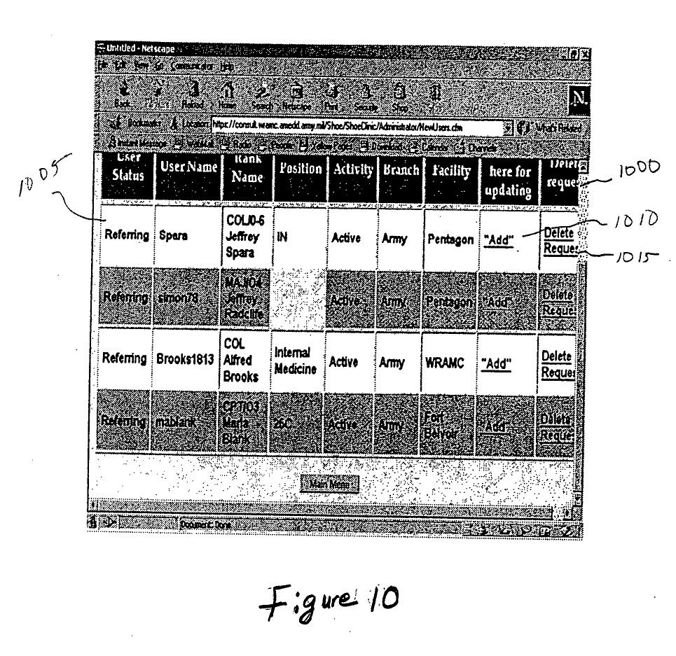

For example, a registered health care provider or site manager at the referral site preferably accesses the system by selecting the “running shoe consult system” option and entering a username and password into the prompts. As shown in FIG. 9, upon entering the system, the user (for example, a health care provider) is preferably presented with the following primary options on exemplary menu screen 900: “approve new referral” option 902; “new patients on-line” option 903; “create new consult” option 904; “create new interview/data sheet consultation” option 906; “create shoe recommendations” option 908; “create new running shoe clinic report” option 910; “editor” option 912; and (8) “statistics” option 914.

As previously described, all users of the consultation management telecommunication system of the present invention must register with the system. As also previously described, for example, after a health care provider selects the “health provider registration online” option 520 in FIG. 5, in at least one embodiment, the registration must be approved by a site administrator, for example. Thus, the site administrator preferably selects the “approve new referral” primary option from the exemplary menu screen 900 in FIG. 9.

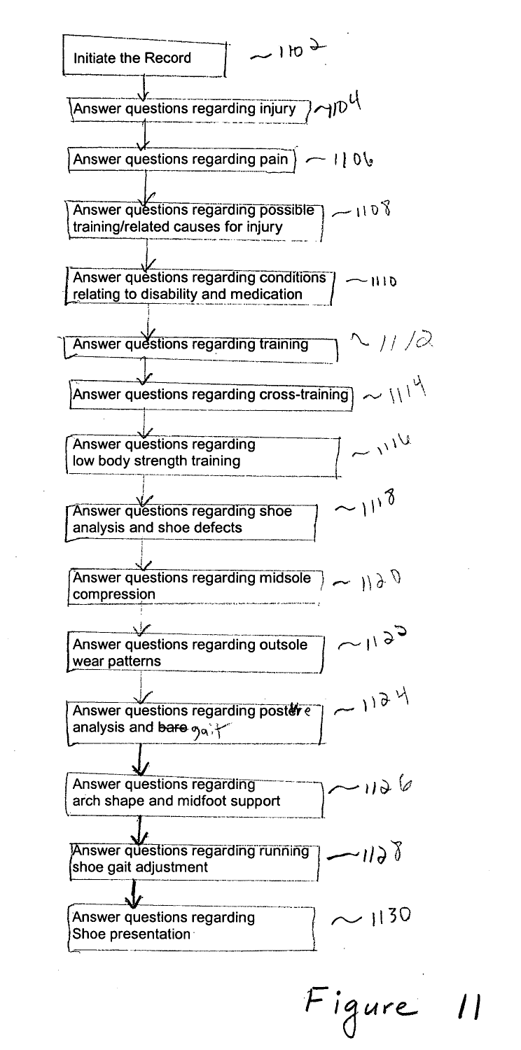

Upon selection of the “approve new referral” primary option, the authoritative user (for example, the site administrator) is preferably presented with exemplary screen 1000, as illustrated in FIG. 10. The exemplary screen 1000 depicts a list 1005 of new referral or consulting health providers including their associated information (for example, position and facility). The list 1005 represents the referring and consulting health care providers who have submitted on-line provider registration forms as described in the text accompanying FIG. 6. These on-line provider registration forms are preferably in a queue awaiting approval from the authoritative user.

The site administrator preferably either adds the “request” to register (that is, the on-line provider registration form) or deletes the request. If the site administrator wishes to approve the registration request, he or she selects “add” button 1010. If the site administrator wishes to deny the request, the site administrator selects “delete request” button 1015. The site administrator is preferably notified that the user registration request (that is, an on-line registration form of a health care provider) has been denied and deleted from the system in such a situation. The health care provider is not registered in this case. In at least one embodiment, the system also preferably sends a message to the user who attempted to register with the system informing the user that his or her on-line registration form was denied. Alternatively, the site administrator may approve a user's on-line registration form by “clicking” an “add” button, for example. In such a situation, the site administrator preferably approves the on-line registration form, and the user is preferably notified that the registration has been confirmed.

Just as the registration of new health care providers must be approved, the registration of new patients must be approved. Upon selection of the “new patients online” option 903 from the list of primary options (FIG. 9), the authoritative user (for example, the site administrator) is preferably presented with a screen depicting a list of new patients including their associated information (for example, facility). The list represents new patients who have submitted on-line patient registration forms as described in the text accompanying FIG. 8. The health care provider on-line registration forms are preferably in a queue awaiting approval from the authoritative user. To approve registration of a new patient, the site administrator preferably selects an “add” button, for example. To deny registration of the new patient, the site administrator preferably selects a “delete” button, for example.

In at least one embodiment, hotlinks are present. These links preferably allow the user (for example, a referring health care provider) to create or delete a consult, as will be described below. After registration for a patient is approved, the user may “click” a button to complete an on-line activity data sheet for the newly registered patient. Upon completion of the on-line activity data sheet, the on-line activity data sheet must also be submitted for approval by the site administrator, for example. This is preferably accomplished by providing a “submit approval request” button on which the user preferably clicks the computer mouse button. As mentioned above, the on-line activity data sheet can be accessed via a primary option and will be described below in the text describing that particular option.

As described in the text above, a patient can separately register, submit his registration for approval and create an on-line activity data sheet to start the consultation process. Alternatively, another user (for example, the referring health care provider, or the patient in at least one embodiment of the present invention) preferably selects the “create new consult” option 904 in FIG. 9. The create new consult option 904 allows the user to register a patient and enter patient data into the on-line activity data sheet for the patient. For example, in at least one embodiment of the invention, an administrator residing at the referring provider site communicates with a new patient over the telephone. In such a situation, the administrator uses the system to initiate consultation of the patient (that is, to register the patient with the system and complete the activity data sheet for the patient) by selecting the option 904 in FIG. 9.

Upon selection of the create new consult option 904 in FIG. 9, the user is presented with an on-line patient registration form, as described in the text accompanying FIG. 6. As described in the text accompanying FIG. 6, the information in the on-line registration form can be updated. After the user enters the requisite registration information for the patient, the user is preferably provided with an option whereby he can elect to complete the on-line patient activity data sheet (for example, a button labeled “on-line patient activity sheet”). The user then preferably asks the patient questions to obtain the requisite information regarding the on-line patient activity data sheet.

G. On-line Patient Activity Data Sheet

The on-line patient activity data sheet allows information obtained from the patient to be entered into the system via on-line forms. The information is preferably included in the report created by the consulting health care provider at the consulting site. The on-line patient activity data sheet preferably includes, but is not limited to, a “consultation identification code” field. A user of the system may later search the system for a particular on-line patient activity data sheet by entering the identification code. In at least one embodiment, this field is automatically assigned to an activity data sheet. For example, a random number generator may be encompassed in the system of the present invention to generate the characters of the identification code. After being presented with the disclosure herein, one skilled in the relevant art will realize that a variety of patterns for the consultation identification code may be utilized. For example, the first two characters of the code may represent the sheet code, the third character may represent an underscore, the forth character may represent the first letter of the referring health provider's last name, and a five digit number after the code may be used to indicate the current number of the consultation for the particular referring health care provider (entered on the patient's registration form). In addition to the consultation identification code, the on-line patient activity data sheet preferably includes a “consult type” field. This field allows the user to enter a particular type of consultation (for example, referral-podiatry).

After the user populates the above-described fields, for example, the user preferably enters exercise training information regarding the patient into the on-line patient activity data sheet. For example, the system preferably prompts the user to answer questions such as, (1) “What is the brand name and style of your current shoe?;” (2) “How long have you been running in the shoes?;” (3) “Do you wear orthotics?;” (4) “Are you being fitted for orthotics?;” (5) “What is your average weekly mileage for the last 6 months?;” (6) “What is your running gait?;” and (7) “Do you have any specific requests concerning running shoes?.” It should be noted that the above list of questions should not be understood to be exhaustive. It should also be noted that the user may answer the questions by selecting possible answers from a group of choices provided, a radio button, entering text into a field, or any other method for allowing the user to respond to a particular question. For example, to respond to the question, “what is your running gait?,” the user preferably highlights one of the following answers: (1) “unknown;” (2) “slight overpronate;” (3) “moderate-severe overpronate;” (4) “underpronate;” and (5) “neutral.”

After completion of the on-line activity data sheet, the user may elect to update the sheet if errors are present or the user simply desires to change the entered information. The user may also elect to delete the sheet.

H. Create On-line interview data sheet

In addition to information from the on-line activity data sheet, the report that will eventually be created by the consulting health care provider at the consulting site also includes technical podiatry-related information from a technical interview session conducted between the referring health care provider and the patient. The information is gathered by the on-line interview data sheet.

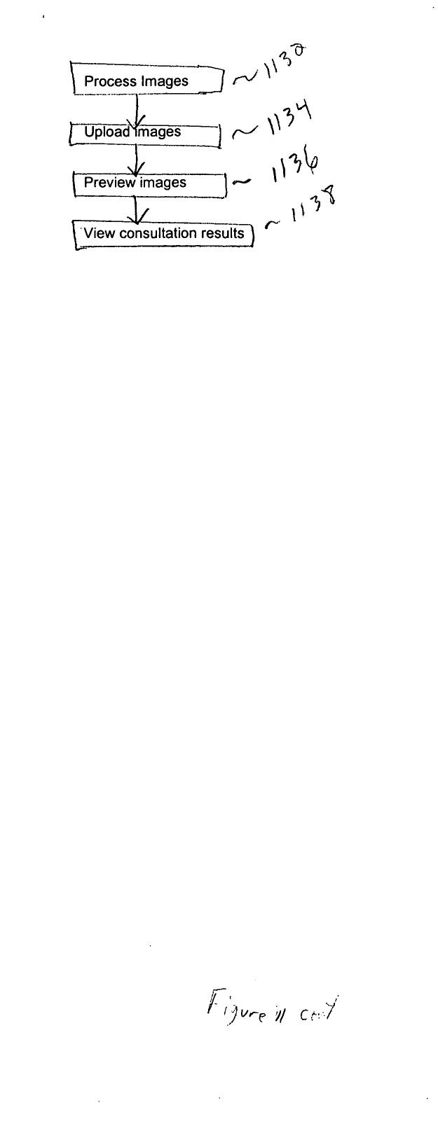

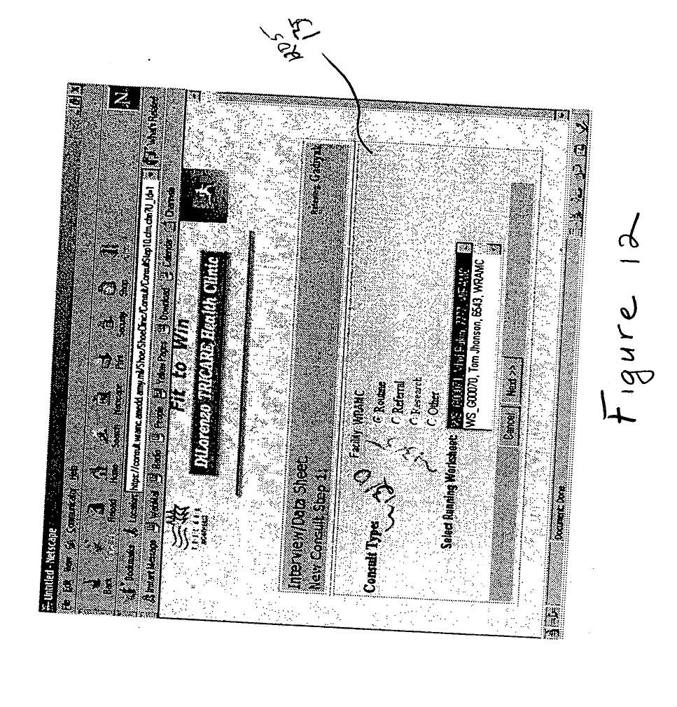

FIG. 11 illustrates the steps involved in entering the variety of information into the on-line interview data sheet. Control begins with step 1102. 081In step 1102, the on-line interview data sheet is initiated. It should be noted that the sheet preferably includes a plurality of forms for entering information in at least one embodiment of the present invention. For example, as shown on exemplary on-line consultation form 1205 in FIG. 12, the on-line consultation form 1205 preferably includes “consult type” field 1210. The field 1210 allows the user to select the type of consultation that the patient will undergo. For example, as illustrated in the form 1205, the user may select from a “routine” type of consultation, a “referral” type of consultation, a “research” type of consultation, or “other” (that is, some other type of consultation). It should be noted that in some embodiments of the invention, the user is presented with a field in which the user preferably selects a particular worksheet to correspond to the on-line form that will be populated with data. For example, as illustrated in FIG. 12, the user is preferably presented with a “select running worksheet” field in which he preferably selects an on-line activity data sheet to correspond to the on-line interview data sheet, as the report that will eventually be created by the consulting health care provider will preferably include information from the on-line patient activity worksheet and the on-line interview data sheet.

In step 1104, the user responds to a plurality of questions regarding injuries. The technical podiatry-related information in the on-line interview data sheet regarding injuries preferably includes questions relating to a variety of types of injuries. The user preferably responds to these questions by selecting “yes” or “no.” In particular, an injury type and its associated injury code are preferably presented on a form. The user responds to this inquiry (whether the user has experienced the particular type of injury indicated) by selecting “yes” or “no” via a radio button format. The user also preferably responds to other inquiry types.

In step 1106, the user preferably responds to a plurality of questions regarding pain from current injuries. These questions are also preferably included in the on-line interview data sheet. The questions include, but are not limited to questions such as: (1) “are you currently injured?”; (2) “if yes, what level of pain are you experiencing?”; and (3) “how long has the injury caused you pain?.”

In step 1108, the user preferably responds to questions regarding possible causes of injuries such as training. Such questions preferably include, but are not limited to: (1) “have you recently increased your speed?”; (2) “if you've recently increased your speed, by how much have you increased it?”; (3) “have you recently increased the frequency of your running?”; (4) “if you've recently increased the frequency of your running, by how much have you increased the frequency?”; (5) “have you recently increased the distance of your running?”; and (6) “if you have recently increased the distance of your running, by how much have you increased it?.” The user preferably responds to these inquiries by entering text into the respective fields to indicate his response. For example, the user may enter 2 days in response to the question regarding how much the user has increased his frequency of running.

In step 1110, the user preferably responds to questions regarding conditions relating to disability and medication. Such questions preferably include: (1) “Are you taking prescription medication?;” (2) If “yes,” for how long have you taken prescription medication?;” (3) “What is the total number of lost training days due to injury?;” (4) “How many work days have you lost due to injury?;” (5) “If you are not running and/or you have not been running, have you felt more stress?;” and (6) “If yes, enter the level of stress.”

In step 1112, the user preferably responds to questions regarding training. For example, such questions include, but are not limited to: (1) “How many miles have you run in the past month?”; (2) “How often?”; and (3) “On what running surface do you typically run?.”

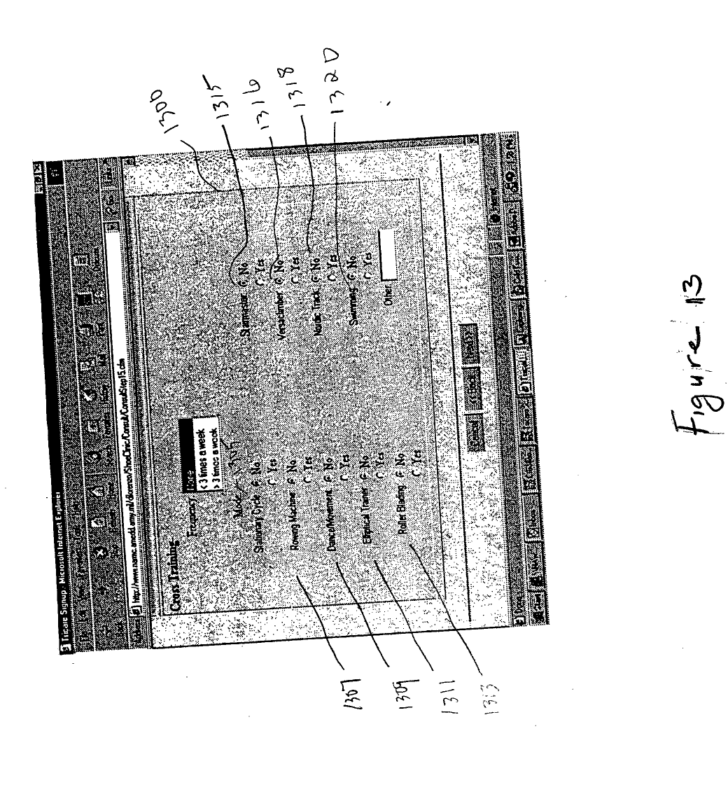

In step 1114, the user preferably responds to information presented regarding patient cross-training. Such questions preferably include (1) “How often do you engage in cross-training?.” The user is also preferably provided with a list of exemplary cross-training activities or exercises, as depicted in FIG. 13. For example, screen 1300 depicts: Stationary Cycle Mode field 1305; Rowing machine field 1307; Dance/movement field 1309; Elliptical trainer field 1311; Roller Blading field 1313; Stairmaster field 1315; Versaclimber field 1316; Nordic track field 1318; and Swimming field 1320. It should be noted that although the user preferably answers these fields by selecting “yes” or “no” via a radio button, other methods of selection may be allowed (for example, highlighting a choice).

In step 1116, the user preferably responds to information regarding low body strength training. For example, the user may select a level of flexibility from a “pull-down” field or a frequency with which the user performs lower body strength training from a “pull-down” field.

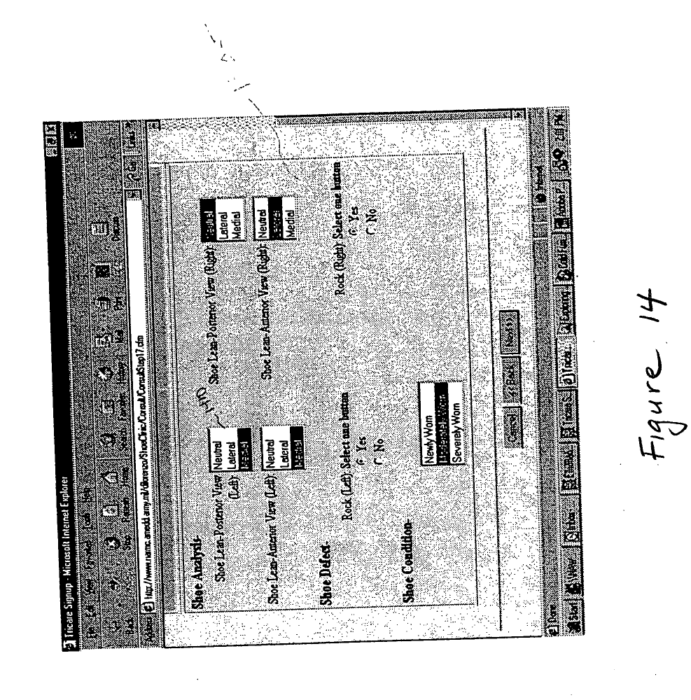

In step 1118, the user preferably enters information regarding shoe analysis and shoe defects. For example, in form 1405 in FIG. 14, the user may select an appropriate “shoe lean-posterior view” for the left shoe from a pull down list 1410 including a “neutral” choice, a “lateral” choice, and a “medial” choice.

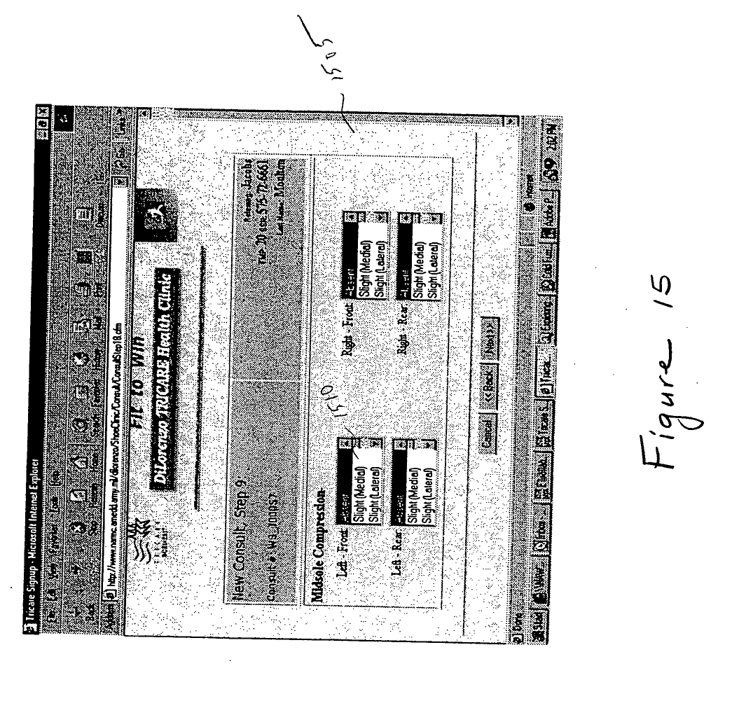

In step 1120, the user preferably enters information regarding midsole compression. For example, in form 1505 in FIG. 15, the user may select an appropriate front midsole compression level for the left foot from a pull down list 1510 including an “absent” choice, a “slight (medial)” choice, and a “slight (lateral)” choice.

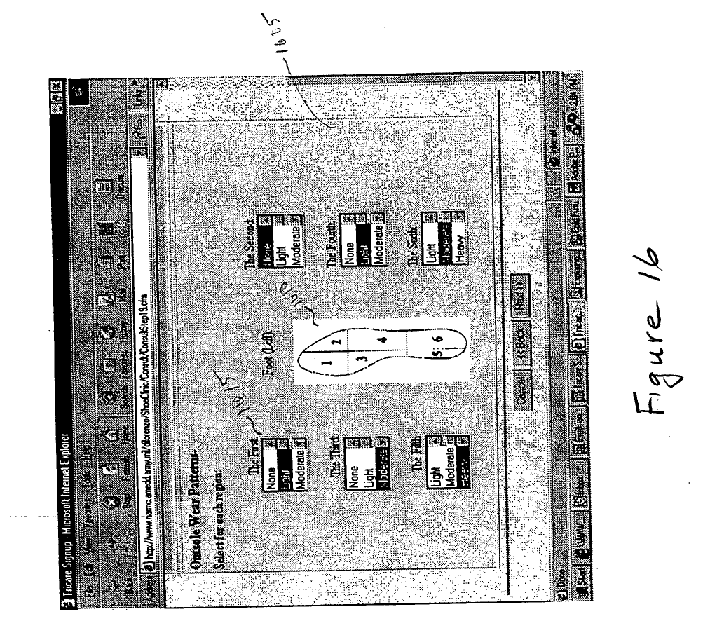

In step 1122, the user preferably answers questions regarding outsole wear patterns. For example, FIG. 16 illustrates an exemplary form 1605 in which the user preferably enters information. Exemplary form 1605 includes a graphical display 1610 of an outsole of a shoe. The exemplary graphical display 1610 is compartmentalized into six sections. It should be noted, however, that the graphical display 1610 may be compartmentalized into a fewer or greater number of sections in other embodiments of the invention. The form 1605 further includes a pull-down list corresponding to each compartment of the graphical display 1610. For example, the pull-down list 1615 corresponds to compartment “1” in the graphical display 1610. The user preferably selects the level of wear that best describes the portion of his or her outsole corresponding to compartment “1” on the graphical display 1610.

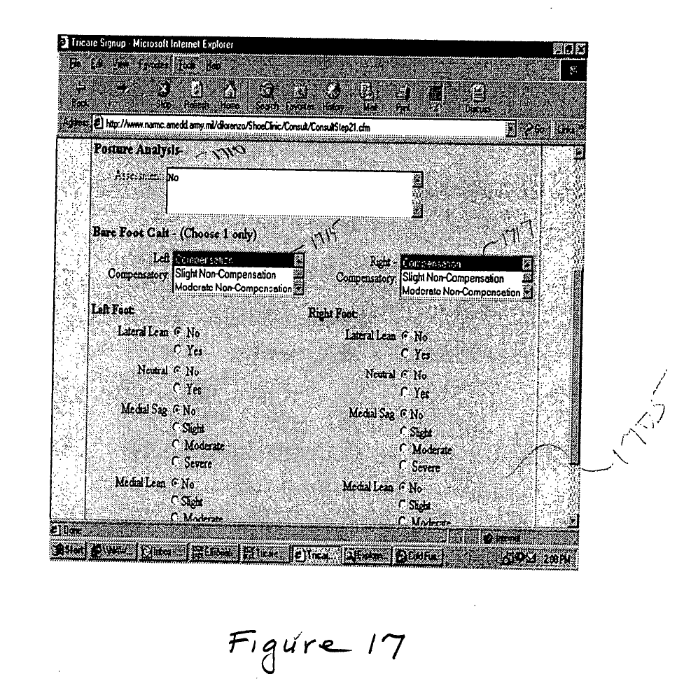

In step 1124, the user preferably enters information regarding posture analysis and gait. For example, FIG. 17 illustrates an exemplary form 1705 in which the user preferably enters information. Exemplary form 1705 includes a “posture analysis” field 1710 and a “bare foot gait” section of the form. The user preferably enters text into the field 1710 regarding the user's standing posture, for example. The “bare foot gait” section of the form 1705 preferably includes pull-down list 1715 relating to the left foot of the patient and pull-down list 1717 relating to the right foot of the patient. The user may select a level of compensation from the lists preferably including “compensation,” “slight non-compensation,” and “moderate non-compensation.” As also illustrated in FIG. 17, the “bare foot gait” section further preferably includes information regarding “lateral lean,” “neutral,” “medial sag,” and “medial lean” for both feet. It should be noted that in some embodiments of the invention, only a subset of the information depicted in FIG. 17 may be present at the referral site. In other words, the information provided may vary according to the site from which the user accesses the system. Thus, for example, the list 1715 may only be presented at the consulting site.

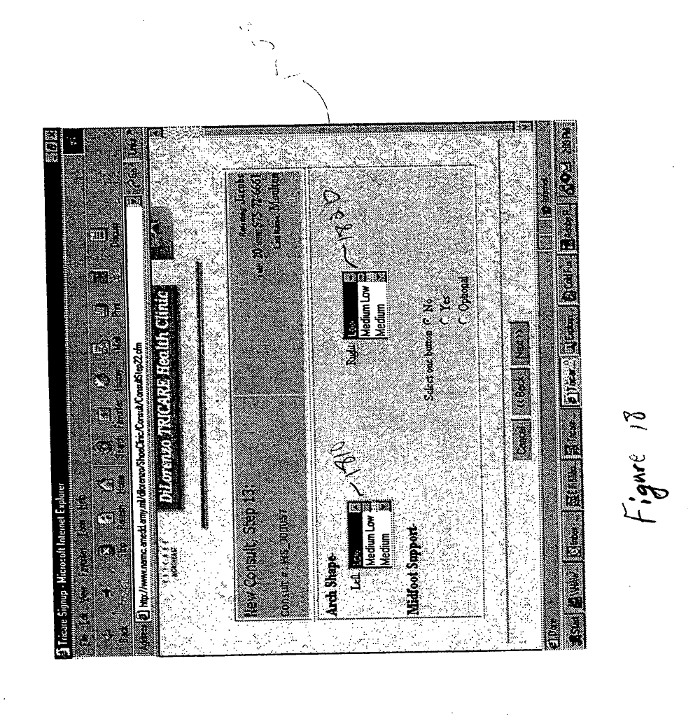

In step 1126, the user preferably enters information regarding the shape of the user's arch and whether the user has support from the midfoot. For example, FIG. 18 illustrates exemplary form 1805 in which the user selects the shape of his arch for each foot from pull-down list 1810 and 1820. The lists preferably include “low,” “medium low,” and “medium,” for example. As illustrated in FIG. 18, the user also preferably selects whether the user has midfoot support.

In step 1128, the user preferably answers questions regarding shoe gait adjustment. It should be noted that in at least one embodiment, this information is preferably available only at a consulting site, as this information typically requires special knowledge (for example, specialized knowledge of the consulting health care provider at the consulting site). The information includes information similar to that entered by the user in FIG. 17. The information entered in step 1128, however, relates specifically to the adjustment of the information (after the consulting health care provider adds arch supports to the patient's shoes, for example).

In step 1130, the user preferably answers questions regarding shoe presentation. For example, the user preferably enters remarks into a data field regarding the gait of the patient while running in running shoes.

In step 1132, the user preferably obtains images of the patient while performing activity. For example, the user may video tape the patient while running or walking on a treadmill once while bare-footed and at another time while shoed.

In step 1134, after the images are placed in digital format, an administrator at the referring site preferably uploads the images directly into a form, as the images will become a part of the on-line interview data sheet.

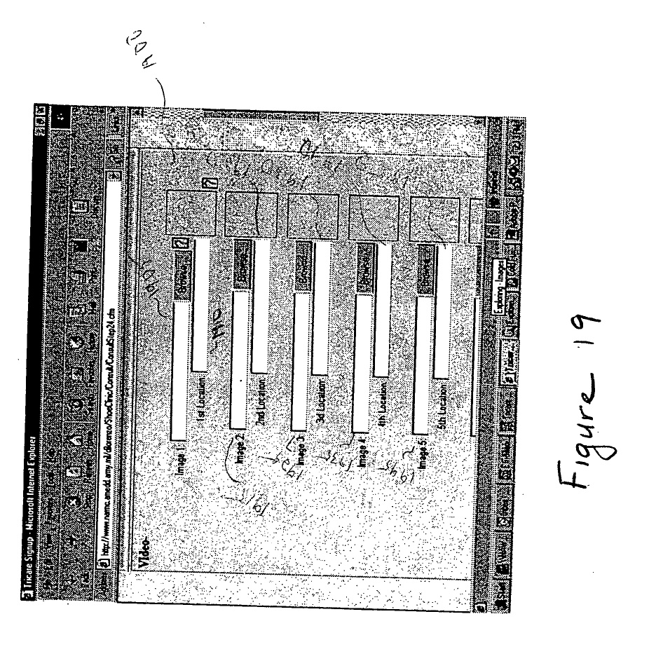

For example, FIG. 19 illustrates an exemplary form 1900 in which a plurality of images are preferably uploaded to the system of the invention. In particular, for example, the form 1900 includes fields 1905, 1910, 1915, 1920, 1925, 1930, 1935, 1940, 1945, and 1950. The user preferably “browses” a drive and uploads an image to the system via image field 1905, for example. The user preferably enters text into text field 1910 to describe or make a particular note about the image (for example, gait analysis with shoes or gait analysis without shoes).

In step 1136, all images are preferably previewed to ensure quality. In step 1138, all information in the on-line interview data sheet is viewed. The user may also update the entered information, as described earlier with respect to other information. After the user is assured that all information is correct, the user can submit the information to the system (for example, save the information to the system). The on-line interview data sheet now has a “new” status, and the status will preferably remain unchanged until the consulting health provider enters the shoe recommendations.

I. Create Shoe Recommendations

Upon selecting the “Create shoe recommendations” option from the list of primary options, the user is presented with a form including an option to allow selection of a particular on-line interview data sheet with an associated “consult #” used to identify the selected on-line interview data sheet. The user then creates recommendations for the patient based on the on-line interview data sheet and the on-line patient activity data sheet described above. The information in the recommendation preferably relates to (1) shoe effectiveness; (2) whether the patient was presented in a biomechanically correct running shoe; (3) whether the running shoe was serviceable at the presentation; and (4) a recommended shoe type and shape (for example, cushioned, stability, motion control, straight, semi-curved/straight, semi-curved, semi-curved/curved, curved).

The information further preferably includes information relating to: (1) shoe construction board; (2) combination material; (3) slop; (4) strobel-slip; (5) midsole recommendations (for example, soft, moderately firm, most firm); (6) barefoot running gait (for example, underpronate, neutral, slight over pronate, moderate-severe overpronate); and information regarding special shoe needs. In at least one embodiment of the present invention, the system also preferably presents the user with a list of recommended shoes for the patient. For example, the list may include the name of the shoe, the stability, and whether it is a male shoe or a female shoe. After responding to the above described information, the user then preferably saves the information and views and/or updates the information. It should be noted, that a user may also delete the recommendation.

J. Create New Shoe Clinic Report

The running shoe clinic report is preferably a running shoe technical report created by the consulting health care provider based on information previously entered at the referral site. Upon selecting the “Create New Running Shoe Clinic Report” option from the list of primary options, the user is presented with a form including an option to allow selection of a particular on-line interview data sheet with an associated “consult #” used to identify the selected on-line consultation sheet. As previously mentioned, the information from the selected on-line interview data sheet will be used in creating the report. Thus, the selected on-line interview data sheet will be paired with the new technical report. The technical report preferably includes information relating to: (1) shoe type; (2) foot shape; (3) gait; (4) mileage specification; (5) arch and shoe shape; (6) running gait; (7) midsole; (8) type; (9) orthotics; and (10) midfoot support. It should be noted that some of the information is preferably obtained from the on-line interview data sheet. It should also be noted that the report may be updated or deleted. Further, in at least one embodiment, the report may be assigned an identification number. In at least one embodiment of the invention, a computer program statistics module is preferably provided to inform a user of statistics related to information in the system.

K. Editor

The information entered through the primary options described above (for example, the information in the on-line interview data sheet and the information in the on-line patient activity worksheet, etc.) can be edited, updated, or deleted by using the “editor” primary option. For example, a system administrator may wish to delete a particular on-line interview data sheet.

Upon selecting the “editor” primary option, the user is presented with a list preferably including the following choices: (1) “editor for uploading and deleting images;” (2) “editor for shoe names;” (3) “editor for referring and consulting health care providers;” (4) “editor for registration form;” (5) “editor for patient registration form;” (6) “editor for running worksheet;” (7) “editor for on-line interview data sheet;” (8) “editor for recommendations;” (9) “editor for reports;” (10) “editor for shoe company phone numbers” (will be described later below); and (11) “editor for user's guide” (will be described later below). Some of the choices mentioned above may include sub-options (for example, “delete,” “update,” or “add”) which are preferably selected by the user. For example, under the “editor for shoe names” choice, a plurality of sub-options are preferably present including: (1) a table of shoe names; (2) “add a new shoe name;” (3) “update an existing shoe name;” and (4) “delete an existing shoe name.” By selecting one of the above sub-options, the user may obtain a listing of the information, update the information, or delete information pertaining to the feature of the option (for example, delete a particular report).

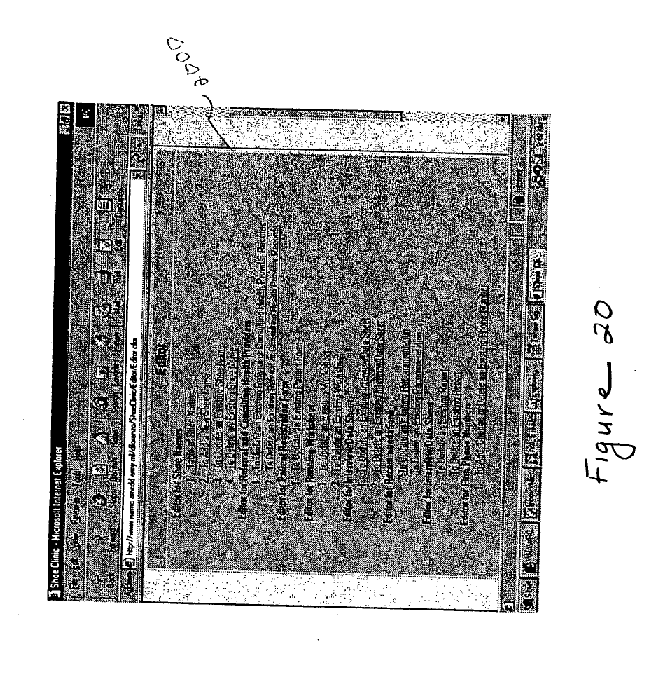

FIG. 20 illustrates an exemplary screen 2000 presented after the user selects the “editor” option from the list of primary options. As the options in the exemplary screen 2000 are self-explanatory, most of them will not be described further herein.

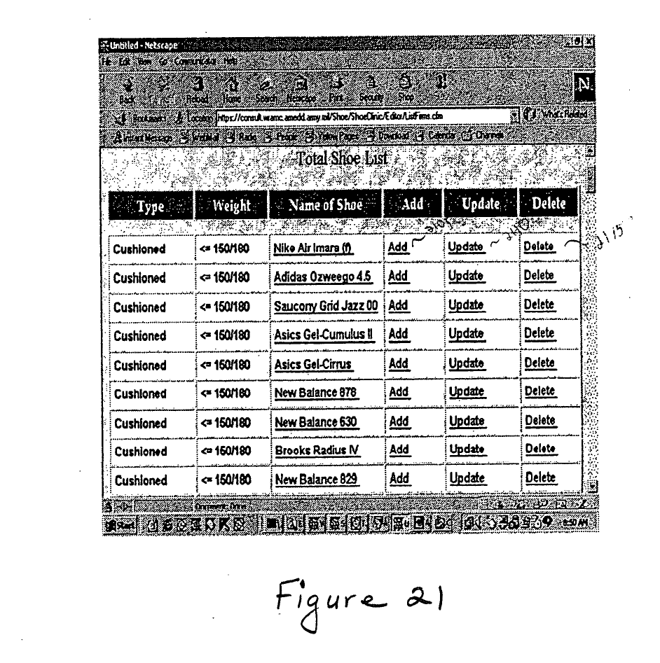

FIG. 21 illustrates an exemplary screen 2100 presented after the user selects the “a table of shoe names” sub-option under the “editor for shoe names” option on exemplary screen 2000 in FIG. 20.

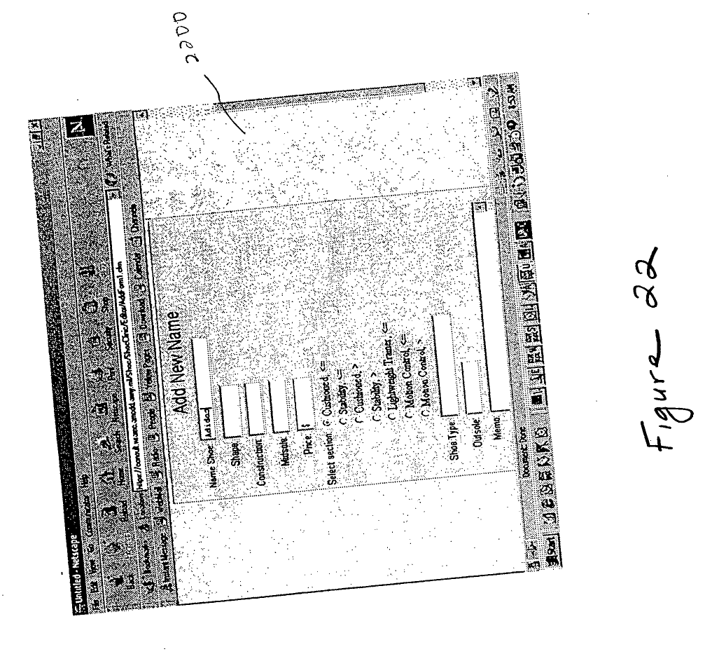

The exemplary screen 2100 includes a list 2105 of information relating to specific shoes. For example, the type, weight, and name of the particular shoe are listed. The user may update or delete the first named shoe (“Nike Air Imara”), for example, by “clicking” the computer mouse on one of the hotlinks 2110 or 2115. For example, FIG. 22 illustrates exemplary screen 2200. The exemplary screen 2200 preferably appears after the user selects the “add” hotlink 2105 from the screen 2100 in FIG. 21. The information in exemplary screen 2200 includes fields of information pertaining to the new shoe that are preferably populated by the user.

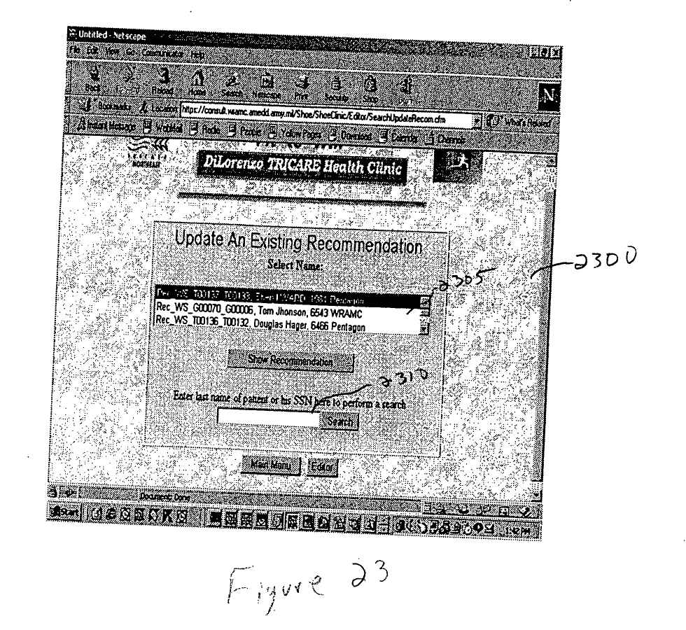

As mentioned above, an update sub-option (for example, “update” hotlink 2110 in FIG. 21) is preferably included under some of the options described above (for example, the “editor for shoe names” option in FIG. 20). Such a sub-option allows a user to alter previously entered information (for example, change the name of a particular shoe). For example, under the “editor for shoe names” option on screen 2000 in FIG. 20, a sub-option entitled, “to update an existing shoe name” is preferably offered. FIG. 23 illustrates an exemplary screen 2300 presented after the user selects the sub-option entitled, “to update an existing shoe name.” As illustrated in FIG. 23, a list 2305 of shoe recommendations currently stored in the system is preferably presented on screen 2300. Shoe recommendations can be quickly located by searching by a patient's last name, for example. The search results in locating the recommendation for the patient whose last name was entered. In particular, the exemplary screen 2300 includes a search field 2310 in which the user preferably enters a string of text representing a patient's last name to search for his or her corresponding recommendation. After the system “finds” the information (for example, a record from a database in the system including the information), the user is allowed to update the information. After being provided with the disclosure herein, it will become apparent to one skilled in the relevant art that a variety of methods by which searching may occur are possible. For example, in some embodiments, the system may allow the user to search by first name or name of the shoe, etc.

Those skilled in the art will appreciate that various adaptations and modifications of the above-described embodiments can be configured without departing from the scope and spirit of the present invention. Therefore, it is to be understood that, within the scope of the appended claims, the invention may be practiced and constructed other than as specifically described herein.

1. A consultation management telecommunication system for providing podiatry-related consultation to a patient, comprising:
a computer program registration module including computer readable instructions for allowing user registration with the system;
a computer program consultation creation module including computer readable instructions for accepting patient activity information for assisting in consultation of the patient;
a computer program consultation interview module including computer readable instructions for accepting technical podiatry-related information for assisting in the consultation of the patient;
a computer program recommendation module including computer readable instructions for generating a technical shoe recommendation based on the consultation of the patient; and
at least one workstation including a microprocessor for executing said computer program modules.

2. The consultation management telecommunication system of claim 1, further comprising a computer program authorization module including computer readable instructions for allowing the user to authorize the registration.

3. The consultation management telecommunication system of claim 1, further comprising a computer program technical report module including computer readable instructions for allowing the user to generate a technical report based on said technical recommendation.

4. The consultation management telecommunication system of claim 3 further comprising a computer program editor module including computer readable instructions for allowing said user to update, alter, add, and delete information pertaining to the system.

5. The consultation management telecommunication system of claim 1, further comprising a computer program statistics module including computer readable instructions for generating statistics regarding patient injuries.

6. The consultation management telecommunication system of claim 2, wherein said computer program authorization module includes computer readable instructions for allowing said user to add or delete said registration.

7. The consultation management telecommunication system of claim 6, wherein said computer program authorization module further includes computer readable instructions for allowing a user to confirm said addition or deletion.

8. The consultation management telecommunication system of claim 1 wherein said consultation creation program module includes computer readable instructions for allowing patient registration with the system.

9. The consultation management telecommunication system of claim 1 wherein said consultation creation program module includes computer readable instructions for allowing said user to respond to a series of queries pertaining to exercise activity information to create an on-line worksheet, said computer readable instructions also allowing the user to update said on-line worksheet.

10. The consultation management telecommunication system of claim 9 further comprising a computer program worksheet confirmation module including computer readable instructions for allowing a user to confirm said worksheet.

11. The consultation management telecommunication system of claim 9, further comprising a computer program worksheet deletion module including computer readable instructions for allowing a user to delete said worksheet.

12. The consultation management telecommunication system of claim 9, wherein said series of queries relate to at least one of orthotics, running gait, and physical measurements.

13. The consultation management telecommunication system of claim 1, wherein said consultation interview module further includes computer readable instructions for allowing said user to select a type of consultation.

14. The consultation management telecommunication system of claim 1, wherein said consultation interview module further includes computer readable instructions for allowing said user to select a particular worksheet to be used in consultation of the patient.

15. The consultation management telecommunication system of claim 1, wherein said consultation interview module includes computer readable instructions for allowing said user to respond to a series of queries pertaining to said technical podiatry-related information.

16. The consultation management telecommunication system of claim 15, wherein said technical podiatry-related information relates to at least one of injuries, physical training activity, physical ability, footwear, posture, and gait.

17. The consultation management telecommunication system of claim 1, further comprising an image uploading program module including computer readable instructions for allowing said user to upload a video image from a referral site and transfer said image to a consultant site.

18. The consultation management telecommunication system of claim 17, further comprising an image preview program module including computer readable instructions for allowing said user to preview said image before transferring said image to said consultant site.

19. The consultation management telecommunication system of claim 1, further comprising a technical podiatry-related information update module for allowing a user to update said technical podiatry-related information.

20. The consultation management telecommunication system of claim 1 wherein said technical recommendation includes answers to a series of questions provided to said user, said questions related to information for determining an appropriate shoe for a patient.

21. The consultation management telecommunication system of claim 20 further comprising a computer program shoe recommendation update module for allowing said user to update said answers.

22. The consultation management telecommunication system of claim 20 further comprising a computer program shoe recommendation delete module for allowing said user to delete said recommendation.

23. The consultation management telecommunication system of claim 20 further comprising a computer program shoe recommendation delete module for allowing said user to delete said recommendation.

24. The consultation management telecommunication system of claim 3 wherein said technical report includes information from said technical podiatry-related information and said technical recommendation.

25. The consultation management telecommunication system of claim 3, wherein said technical report module further includes computer readable instructions for allowing said user to update said report.

26. The consultation management telecommunication system of 3, wherein said technical report module further includes computer readable instructions for allowing said user to delete said report.

27. The consultation management telecommunication system of claim 1, wherein said registration module includes a plurality of fields including a user type field, a plurality of demographics fields, a username field, and a password field.

28. The consultation management telecommunication system of claim 27, wherein said computer program registration module further includes computer readable instructions for allowing said user to confirm registration.

29. The consultation management telecommunication system of claim 1, further comprising a computer program menu module including computer readable instructions for providing options to a user via a menu-based format.

30. A method in a telecommunication system for providing automated management of podiatry-related consultation information for a patient, comprising:
allowing a user to provide registration information pertaining to an individual;
receiving activity information pertaining to an individual from a user;
receiving technical podiatry-related information from a medical professional; and
generating a recommendation based on said podiatry-related information.
